(19) United States
(12) Patent Application Publication
(10) Pub. No.: US 2003/0050958 A1
(43) Pub. Date: Mar. 13, 2003

(54) Supplier/reseller interaction

(76) Inventors: Beth A. Keller, Amesbury, MA (US); John R. Marchione, State College, PA (US)

Correspondence Address: FISH & RICHARDSON PC, 225 FRANKLIN ST, BOSTON, MA, 02110, US

(21) Appl. No.: 09/950,570

(22) Filed: Sep. 10, 2001

(51) Int. Cl. G06F 15/16

(52) U.S. Cl. 709/201

(57) ABSTRACT

A method that includes maintaining an on-line facility that provides to a retailing customer of a manufacturer information about the status of transactions involving products of the manufacturer. The information provided on the on-line facility includes information about transactions that are entered by the retailer in the on-line facility and information about transactions that are entered other than through the on-line facility.

### BACKGROUND

This invention relates to supplier/reseller interaction. A large manufacturer of retail items, for example, typically conducts commercial transactions with its large retail customers using electronic transaction processing protocols such as Electronic Data Interchange (EDI). Both sides in the transaction develop and maintain software that enables their computer systems to conduct the steps of EDI transactions with the other party and to execute and report those steps to their internal databases and applications. The internal databases, applications, and EDI software are often large, custom systems that are complex and expensive to create and maintain. The cost of enabling a company to use EDI may be justified by the savings associated with the automated electronic nature of the transactions that can be effected. A small retailer, such as a local shoe store, generally cannot afford to equip itself to conduct EDI transactions with manufacturers. Instead, such a retailer orders merchandise and completes the transactions using largely manual telephone and FAX-based procedures. Many transactions that make up sales to smaller, independent retailers are still received manually through phone and FAX. These conventional techniques are expensive for the manufacturers, especially relative to the small sizes of the orders. The relatively high costs are multiplied by the potentially large number of different retailers with which the manufacturer must conduct business this way. On average, manufacturers are spending from $45 to $65 each time an independent retailer places an order using a paper-based system. On average, a manufacturer may receive more than 100 orders per day, each of which is placed manually from retailers nationwide. It is not unusual for a large manufacturer to deal with several thousand retailers.

Although the transactional costs are high, manufacturers rely on smaller, independent stores to help them differentiate their brands in the market in a way that large chain stores (for example, Wal-Mart) may not be able to do. In addition a manufacturer must maintain geographic market penetration to be a viable brand.

The large databases and applications that a typical manufacturer uses to control its inventories, accounts, and sales transactions are used manually by its sales people in conducting business with small retailers.

### SUMMARY

In general, in another aspect, the invention features a method that includes maintaining an on-line facility that provides to a retailing customer of a supplier information about the status of transactions involving products of the supplier. The information provided on the on-line facility includes information about transactions that are entered by the retailer in the on-line facility and information about transactions that are entered other than through the on-line facility. Implementations of the invention may include one or more of the following features. The information about the status of transactions is provided from a database, the database is updated automatically by the on-line facility to reflect transactions entered by the retailer, and the database is also updated to reflect at least some of the transactions that are entered other than through the on-line facility. The database is maintained independently of the supplier and is synchronized with a database maintained by the supplier by electronic communication.

Other advantages and features will become apparent from the following description and from the claims.

### DESCRIPTION

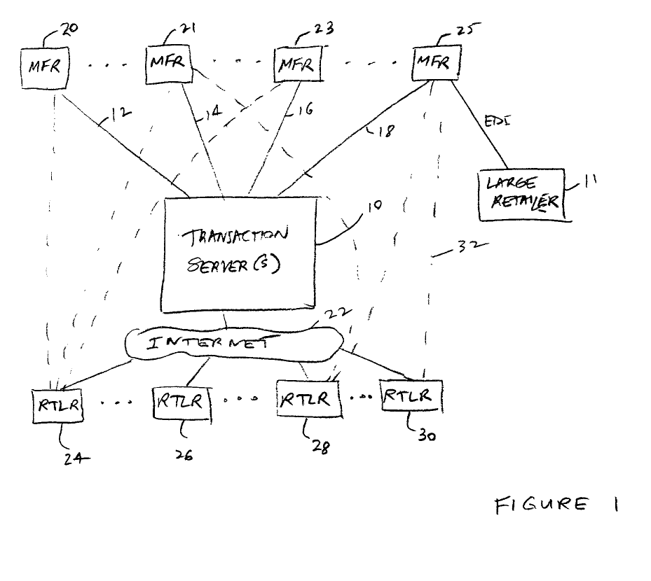

(FIGS. 1 through 11, and 26 are block diagrams.

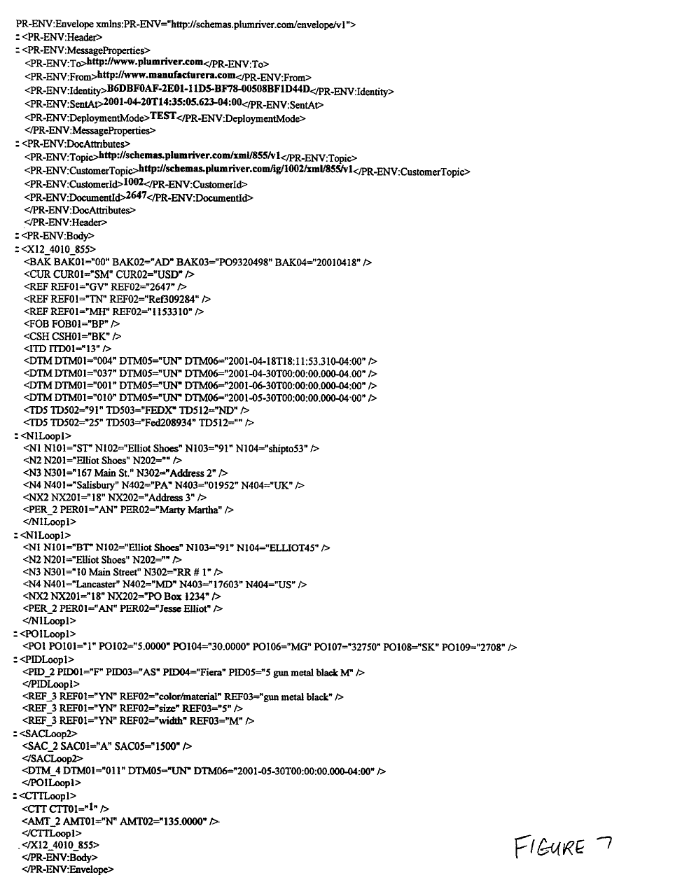

FIG. 7 shows a data structure.

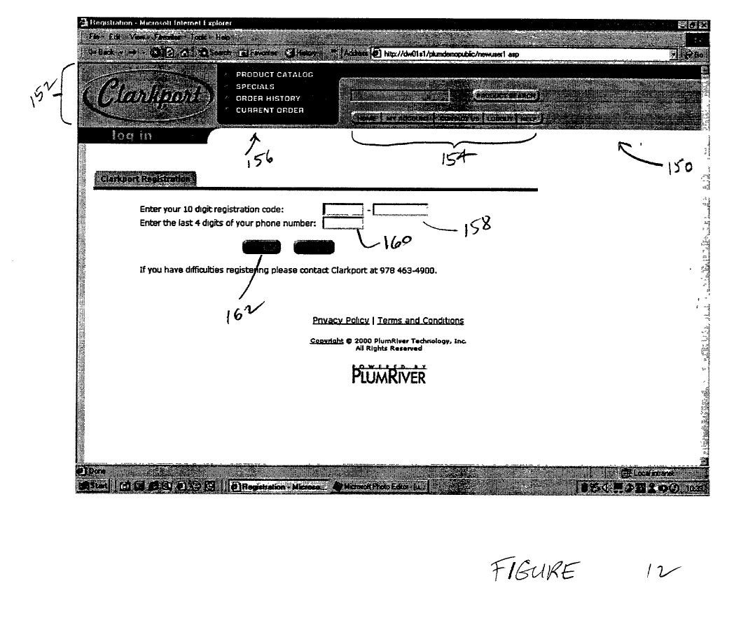

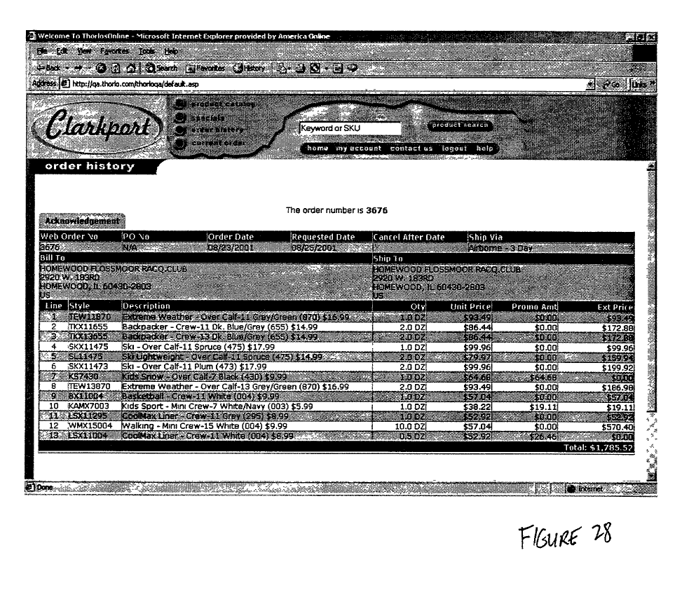

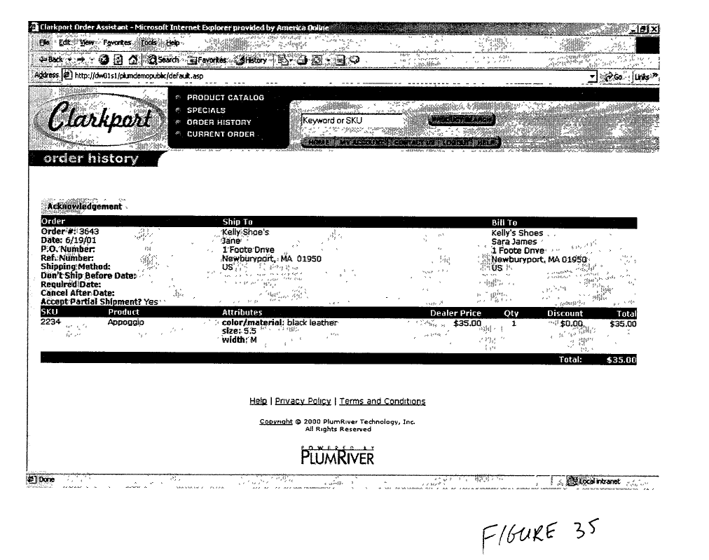

FIGS. 12 through 25, 27, 28, and 35 show web pages.

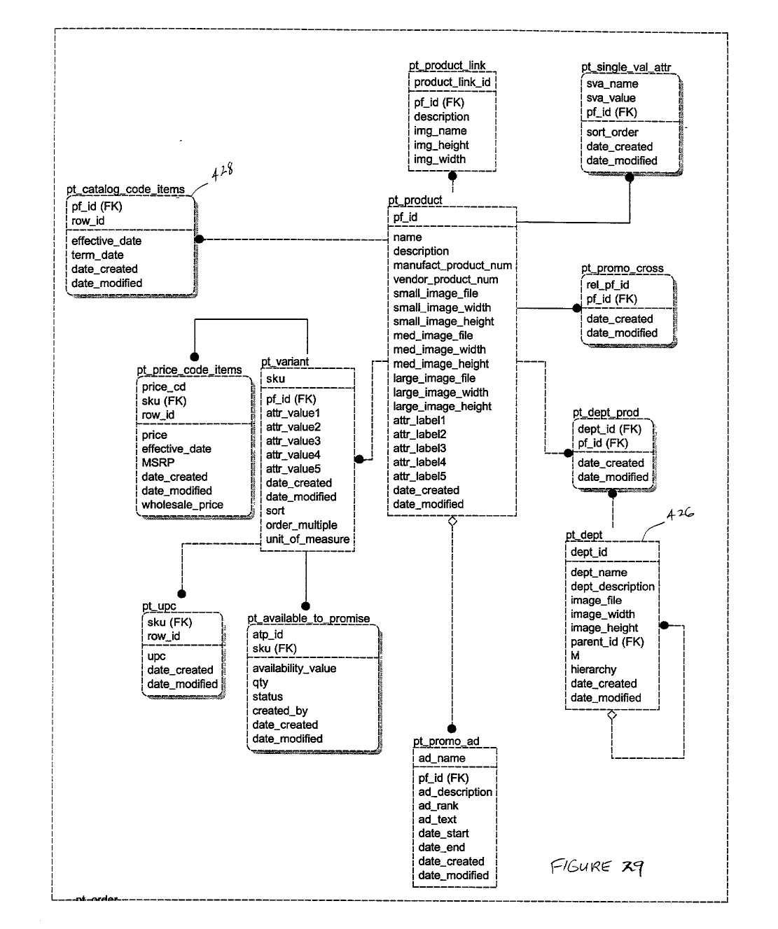

FIGS. 29 through 34 show entity diagrams.)

FIG. 1 shows a system that provides manufacturers with Internet and web based software technology and business process solutions for their interactions with retailers. The system enables manufacturers to provide retailers with a quick and easy way to place orders electronically without the need for the retailer to acquire or implement EDI or other kinds of electronically-enabled transaction protocols. The web technology allows the manufacturers to extend the use of their existing transaction infrastructure to smaller, independent retailers, who are typically placing orders via paper, fax, e-mail, and telephone. Any retailer with a browser may conduct e-commerce with the electronically-enabled manufacturer, thereby maximizing workflow efficiency and saving the manufacturer significant operating costs.

As described in more detail later, the system uses a meta database architecture that permits manufacturers to easily deliver and update the manufacturer's web site content and to replenish information from any existing enterprise resource planning (ERP) system. The system facilitates streamlining sell-side, business-to-business channels and ensures the adoption of sell-side e-business initiatives, including sales, marketing, and customer service support. The system is capable of lowering per order-processing costs by an average of 75% over paper-based systems, improving customer service and forecast accuracy, protecting and enhancing brand, reducing cycle time, and increasing revenues. The system can be supplemented with a methodology for guiding retailers to place orders electronically. And manufacturers can use the system to reduce their cost of sale and order entry costs.

As shown in FIG. 1, a transaction server 10 is connected by communication links 12, 14, 16, and 18 to one or more (potentially a large number) of manufacturers 20, 21, 23, 25 and through the Internet 22 (or other network) to one or more (potentially a large number) of retailers 24, 26, 28, 30. The transaction server enables each manufacturer to conduct commercial transactions (e.g., sales of retail goods) with one or more retailers with whom it has a commercial relationship.

The links between the manufacturers and the transaction server carry two kinds of information: (a) setup data (e.g., information about accounts and retail items) that is downloaded from time to time to set up the transaction server to conduct transactions, and (b) transaction data (e.g., orders, order confirmation, shipping confirmations, invoices) that relates to specific transactions being conducted between the manufacturers and their retailing customers.

The set-up data is typically largely a replication of relevant portions of the large commercial databases that are maintained by a manufacturer to track its inventory, descriptions of its products, prices, and customer accounts. Because the data already exists and is kept current on the manufacturer's database, the information can be easily downloaded weekly, daily, or even more often, in order to keep the information on the transaction server automatically current and synchronized with the manufacturer. Also, a manufacturer can participate in the system shown in FIG. 1 with only a minimal effort that does not require the usual creation of new special databases. A small number of data fields may usefully be added to the manufacturer's database to control the presentation of information to the retailers (as explained below) and sometimes other matters, but the effort involved in adding those additional fields is relatively small.

Each of the manufacturers can download the relevant portions of its own database to the transaction server. At the transaction server, the data can be partitioned and protected by security techniques so that there is little risk of unauthorized disclosure of one manufacturer's information to another manufacturer.

Once the manufacturer's data is stored on the transaction server, the transaction server can support one or more web sites branded for the manufacturer and accessible to the retailers through the Internet. The web sites provide interactive web pages that enable a retailer to use any browser-equipped computer or other device to conduct and complete typical orders for retail goods from each of the manufacturers with which it has a commercial relationship, and without the need to make telephone calls, use the mail, or communicate by FAX.

In conducting transactions between a retailer and a manufacturer, the transaction server interacts with the manufacturer using EDI or whatever commercial transaction protocol the manufacturer normally uses. The manufacturer's computers can therefore interact with the transaction server in the same way that they interact with large retailing customers 11 without the manufacturer's computers being aware or needing to know that, on the retailers' side, the transactions are being conducted outside of the EDI context and through a user-friendly web-browser interface. In effect, the transaction server operates as an aggregator of orders and order information and therefore appears to the manufacturer essentially as just another large retailer.

The manufacturers 20, 21, 23, 25 may have product lines that are similar (shoes, for example), closely related (sporting goods including shoes, clothes, and sporting goods), distantly related (cosmetics and packaged foods), or unrelated. The retailers 24, 26, 28, 30 may be engaged in similar businesses (drugstores) or may be engaged in different businesses (CDs, food, appliances). The dashed lines 32 between retailers and manufacturers suggest how different retailers may have commercial relationships with different combinations of manufacturers and vice versa.

The look and feel of the interactive user interface that is provided by the transaction server through the Internet to retailers may be controlled based on the manufacturer that is being represented or the retailer that is interacting with the transaction server.

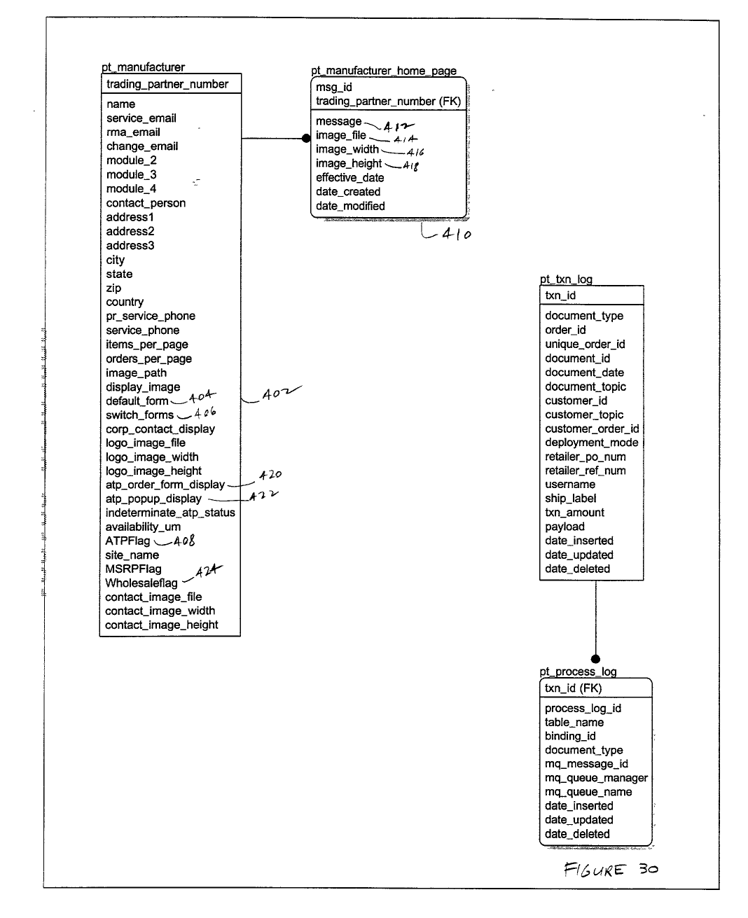

For example, as shown in FIG. 30, within the manufacturer table 42 (pt_manufacturer) a column (default_form) controls the default presentation style (grid versus list based, for example) that will be the basis of capturing ordering quantities from the retailer. An additional column (switch_forms) indicates whether the retailer at runtime can alter the default presentation style. Additionally, a column (ATPFlag) 408 in the pt_manufacturer table controls whether ATP (Available to Promise) labels and values will be presented to the retailer. The look and feel of the site is dynamically influenced by this value.

The look and feel of the web page that the retailer experiences following a successful login, is substantially controlled by attributes in the pt_manufacturer_home_page table 410. The message column 412 defines the introduction text while image_file 414, image_width 416, and image_height 418 columns are used to control the actual web page look dynamically. The pt_manufacturer table further controls the look and feel of ATP data through the atp_order_form_display 420 and atp_popup_display 422 columns. The Wholesaleflag column 424 is used to control the columns which display when presenting pricing information to the retailer. Within the products tables, look and feel is dynamically controlled in numerous ways. The product hierarchy which is experienced by a given retailer is controlled in depth by the pt_dept table 426 (FIG. 29). The pt_catalog_code_items table 428 is used to define products, which are viewable, by the class of retailer.

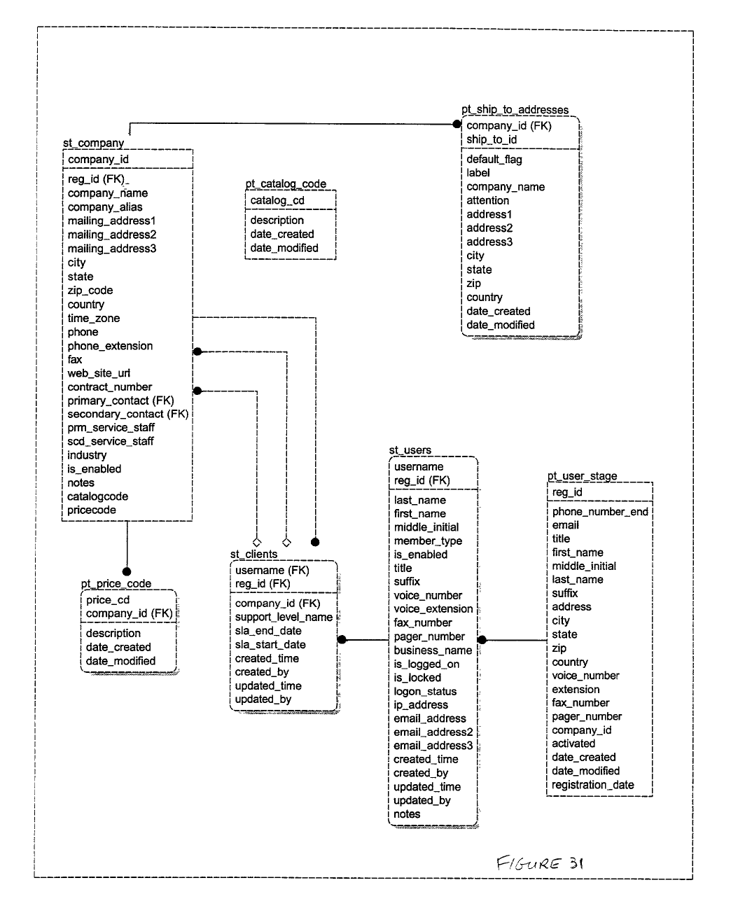

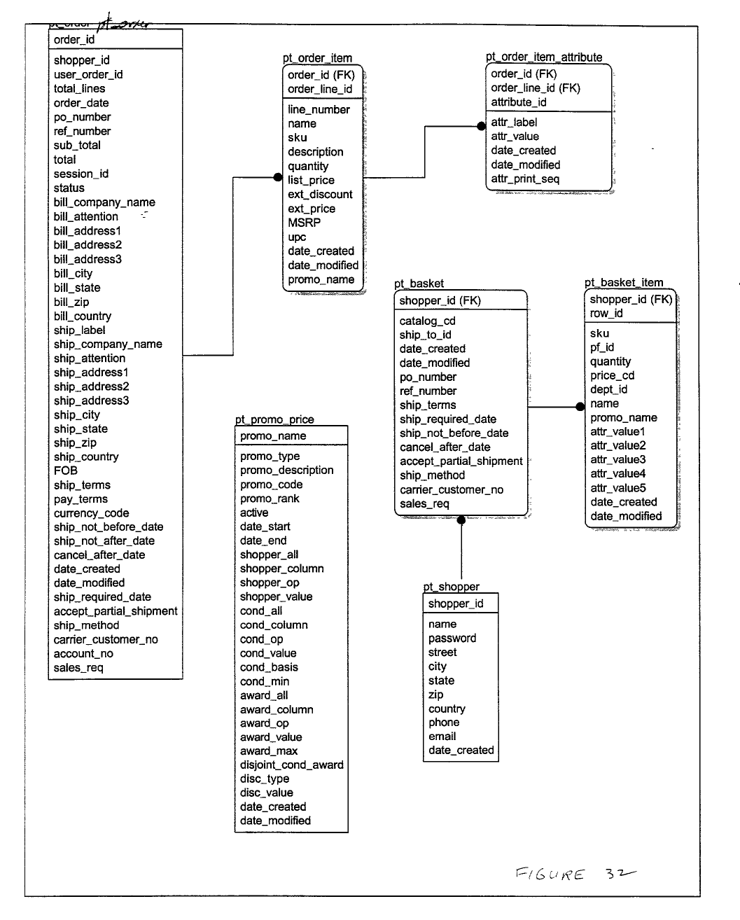

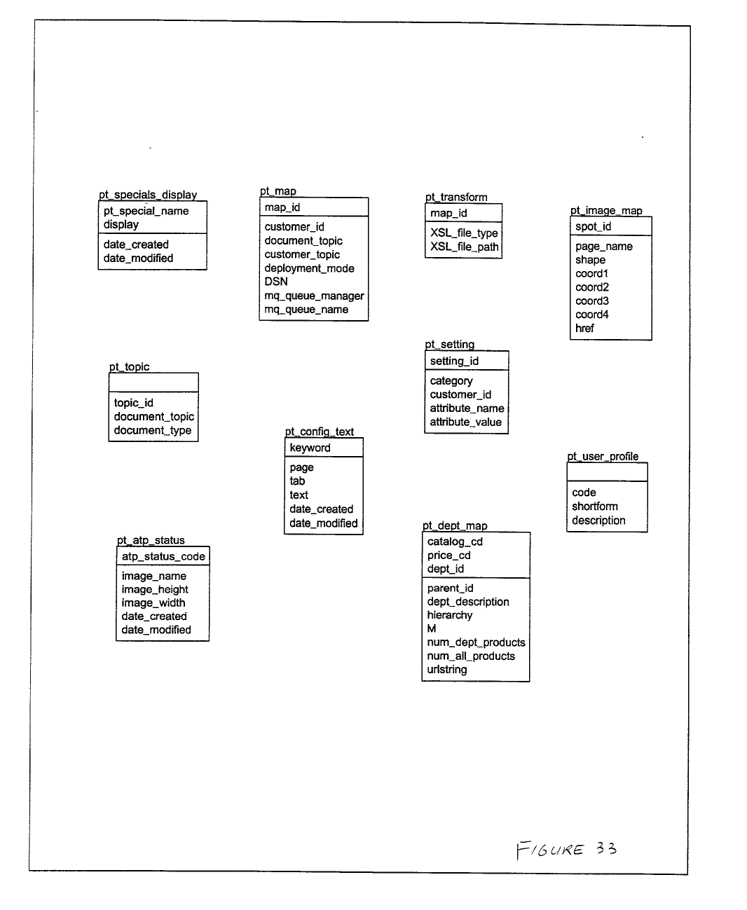

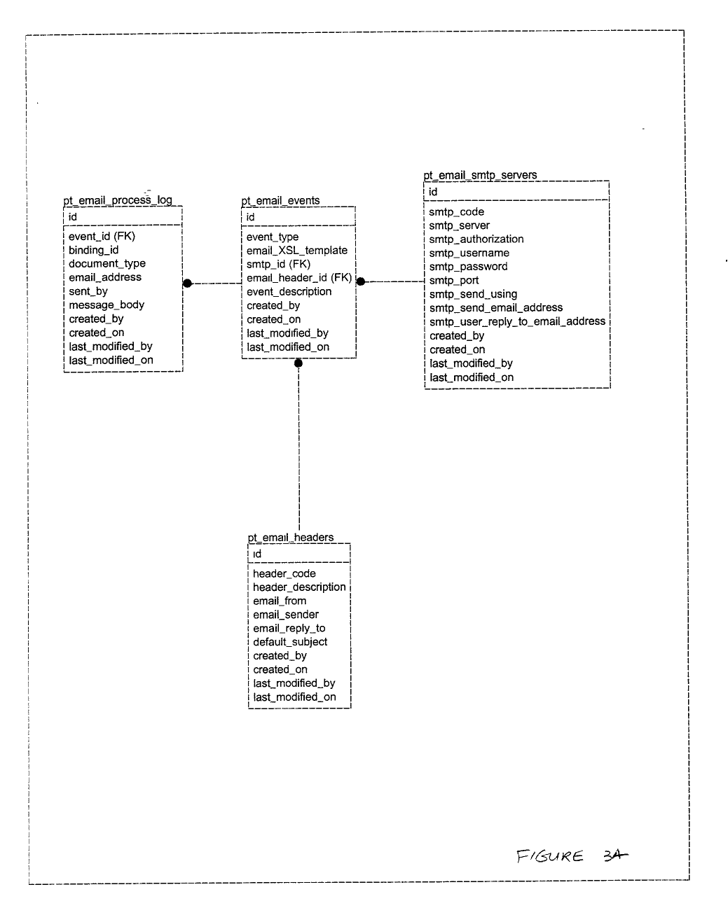

In general, FIG. 29 shows product catalog and pricing related entities, FIGS. 30 shows manufacturer, transaction, and process log related entities, FIG. 31 shows retailer, retailer classification, and buyer related entities, FIG. 32 shows order transaction related entities, FIG. 33 presentation style related entities, and FIG. 34 eMail notifications related entities.

In general, the web pages that are served to a particular retailer at a given time are associated with a single manufacturer and may be constructed to give the retailer the impression that the pages comprise a web site hosted by the manufacturer. If the retailer wishes to place orders with several different manufacturers, he switches from one web site to another.

The manufacturer can arrange for its website to have an appearance that depends on the identity or nature of the retailer that is interacting with the site. For example, the database and application architecture in the transaction server(s) permits a manufacturer to classify or otherwise differentiate among thousands of retailers and then to present different product catalog content and different pricing to different groups of retailers.

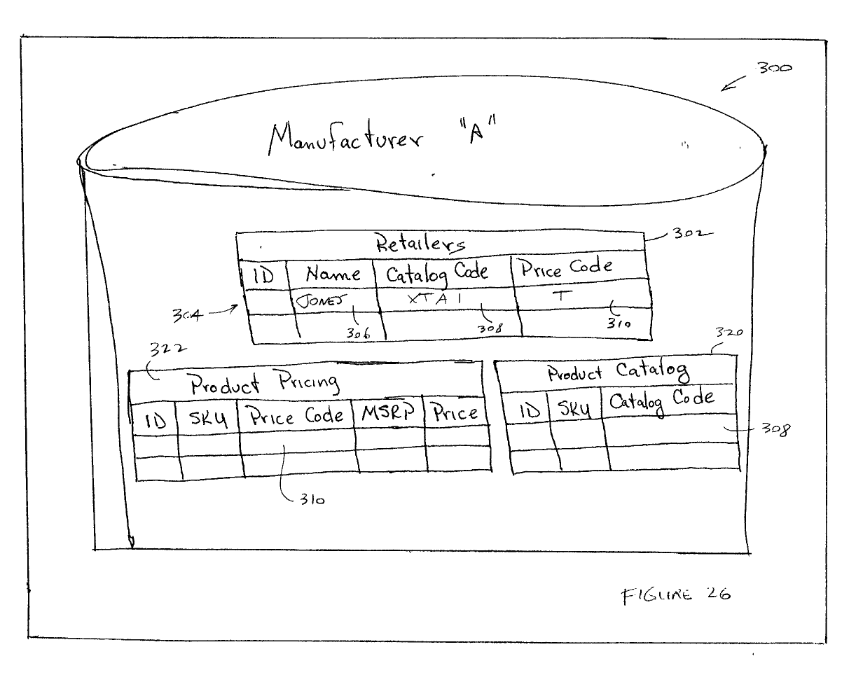

The ability to differentiate among different classes of retailers with respect to catalog content or pricing, for example, is generally referred to as retailer segmentation. FIG. 26 depicts the architecture 300 associated with retailer segmentation. Retailer segmentation is manifested in three principle ways within the system architecture. First, the manufacturer maintains a retailer table 302 each record 304 of which identifies a retailer 306 and a related catalog classification 308, which identifies a specific focus of a retailer's view of the product catalog. That is, the classification defines/restricts the view to products and categories that are to be available to a given retailer or retailer group.

Second, the manufacturer assigns or subscribes a retailer to a pricing classification 310. The pricing classification groups retailers that have like discounts or net prices for products. The price classification operates independently of the catalog classification.

The third way in which retailer segmentation is manifest in the system is through spotlights and specials that are identified and described in advance by the manufacturer. The specific spotlights (typically advertisements of new products) and specials (standard products for which promotions are being conducted) that are presented to a given retailer on the web site are specific to the catalog classification for the retailer. This gives the manufacturer the ability to target different spotlights or specials to different classes of retailers.

As shown in FIG. 26, the catalog code 308 is included in the record for each item of the product catalog table 320. And the price code is included by the manufacturer in each item of its pricing table 322. The abbreviated tables 320, 322 which are part of the transaction server and populated from data in the supplier databases are used to provide the retailers a customized website through the use of classifications.

The tables shown on FIG. 26 relate to tables shown in FIGS. 29 and 31 as follows:

| FIG. 26 Reference | Cross Reference |
|---|---|
| Retailers | FIG. 31, st_company |
| Product Pricing | FIG. 29, pt_price_code_items |
| Product Catalog | FIG. 29, pt_catalog_code_items |

It is useful for all of the web sites of a given manufacturer and of different manufacturers to share at least some (and in some cases many) common user interface elements, which reduces the effort required of the retailers in learning different user interfaces. The ease with which retailers may then interact with a newly offered web site of a manufacturer provides confidence to a manufacturer that, if it becomes a participant in the transaction server system, at least some of the retailers with which it deals may already be familiar with the interface. Because the transaction server serves all of the different websites, it is possible to implement the common elements easily.

Furthermore, within a given market segment, say footwear, if one manufacturer already is a participant and has a large number of retailers who are also participants, it becomes easier to convince other manufacturers of shoes to become participants because they know that at least some of their retailers will already be familiar with the system.

As explained below, the structure of the web pages and the way in which the buyer at a retailer navigates them is designed to reduce the time and complexity needed to complete and manage an order. Among other things, items can be quickly selected for ordering. Information about orders can enter the transaction server either as a result of web-based interaction by retailers or because the order information appears in the manufacturer's database and is replicated onto the transaction server when the relevant portions of the database are periodically downloaded to the transaction server. For example, a retailer might place one order through the web-page interface and another by telephone to a manufacturer's representative. The details of the order placed by telephone, which are entered into the manufacturer's database in the usual way, are downloaded to the transaction server in due course.

The order history information that is available to the retailer on the web site is not limited to the orders that were placed through the web site, but rather includes all of the orders, however placed, that find their way into the manufacturers database, thus providing the retailer a 360-degree view of his order history.

Although the system can produce a significant reduction in the cost that a manufacturer incurs in doing business with a large number of small retailers, the cost reduction can be achieved only if the retailers can be convinced to adopt the system in place of the familiar conventional ordering approach. Adoption of the system both by retailers and manufacturers is facilitated by an adoption strategy and process. For manufacturers, the adoption process includes a guide for preparing and acquiring manufacturer data, project plans, and incentive programs. These elements enable a manufacturer to quickly establish his web site or sites on the transaction server without the need for armies of consultants that are typically required for custom web site creation.

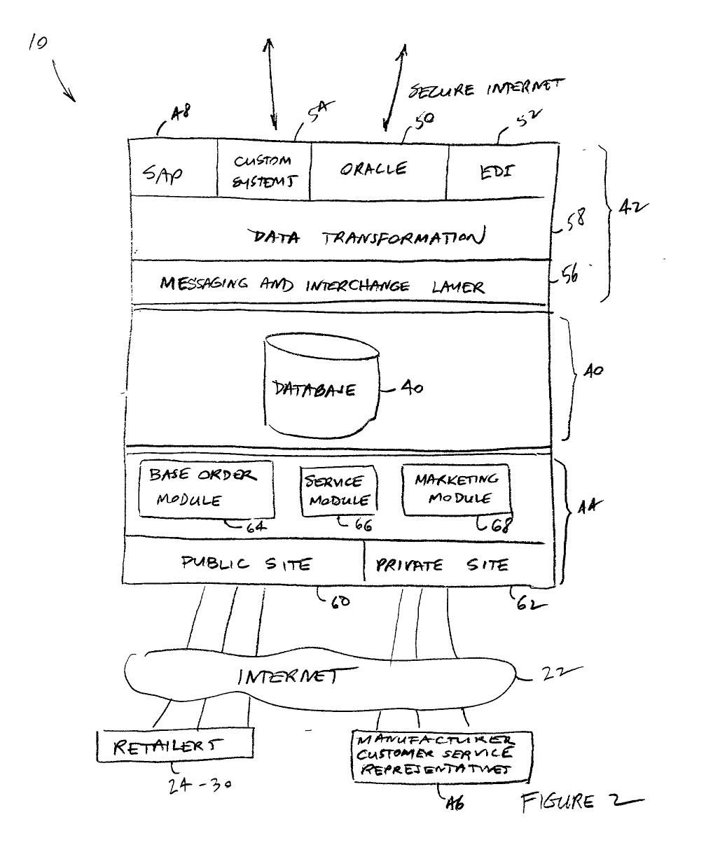

As shown in FIG. 2, the transaction server 10 includes three levels of functionality: a database level 40 that stores the set-up data and the transaction data, a service level 44 that uses the information in the database to provide services through the Internet 22 to retailers 24-30 and customer service representatives (CSRs) 46, and an intake level 42 that interacts periodically with manufacturers (and in some cases wholesalers, point of sale terminals, and other sources of data) to ingest the set-up data and the transaction data and store it in an appropriate format in the database.

The intake level includes the ingestion of data that is made available by database and communication systems that include, for example, SAP 48, Oracle 50, EDI 52, and other custom systems 54. Data may also enter the system through a messaging and interchange layer 56. A data transformation process 58 transforms the data to a common format for storage in the database or reconverts it to other formats for transmission to other parties. The service layer includes web hosting processes that provide public Internet sites 60 used by the retailers, private sites 62 used by the manufacturers Customer Service Representative (CSR's) as needed, and application software that includes a base order module 64, a service module 66, and a marketing module 68.

The base order module serves as a manufacturer's automated order-taking department and is responsible for enabling retailers to place orders, for tracking orders, for checking retailer credit, and for checking item stock with respect to orders being placed.

The service module supports the manufacturer's customer service department and is responsible for maintaining retailer data, issuing return merchandise authorizations, maintaining and reporting service history, providing an electronic medium for responding to retailer inquiries, and maintaining reporting return history.

The marketing module acts as part of the manufacturer's marketing department by tracking and reporting retailer profiles and sales metrics, assisting in creating campaigns and personalizing them, and performing campaign analysis.

Additional point-of-sale and banking modules (not shown) could be provided for servicing point-of-sale terminals and electronic banking facilities. The point-of-sale module could ingest real-time sales information, perform automated ordering, report sales trends, and analyze campaigns. The banking module could provide consolidated retailer invoicing, electronic payment of manufacturers, payment tracking, and purchase card benefit processing.

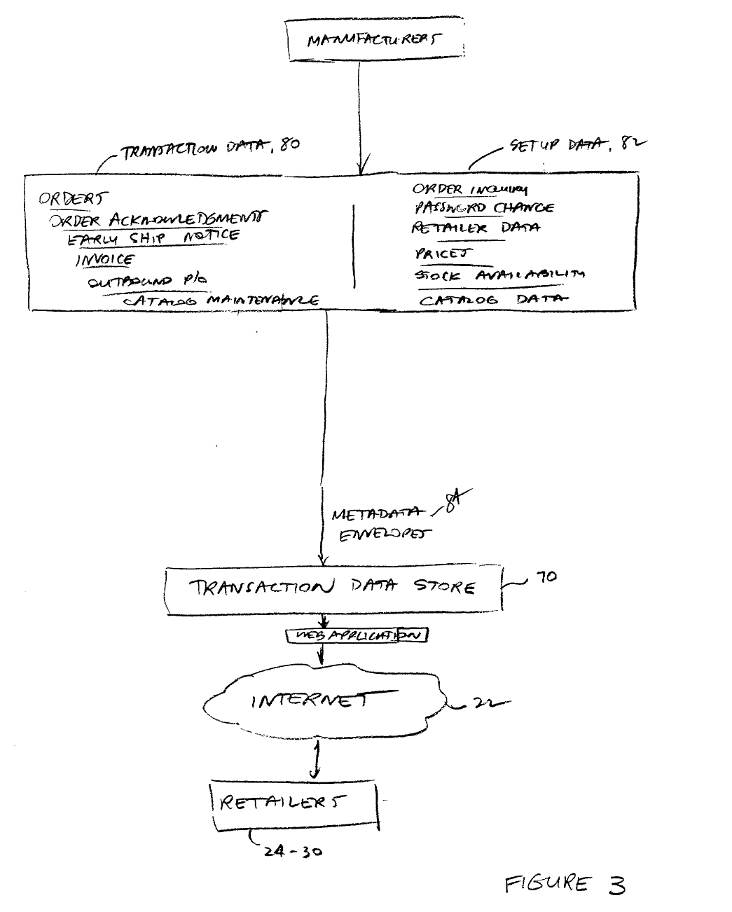

FIG. 3 provides an overview of the flow of transaction data 80 and set-up data 82 from manufacturers to the transaction data store 70 within the overall database 40, and between the transaction data store 70 and retailers 24-30. All transaction data and setup data that is ingested by the system is initially packaged in metadata envelopes 84 and stored in the transaction data store 70. Later, the stored metadata envelopes are processed and transformed in a manner that depends on whether they hold transaction data or set-up data.

Transaction data has its final destination in a transaction log table discussed later. The transaction log table also provides a short-term common storage area for non-transactional data which will be further processed for updating into the various discrete tables, database schemas, and file systems which largely comprise site content database's (e.g. products, pricing, images). All data, whether transactional or non-transactional is processed through the transaction log table—based on abbreviated description/example and pt_txn_log in the more verbose set of tables.

In either case (transactional or non-transactional information), the stored information can later be accessed by retailers through the Internet.

Meta Data Architecture

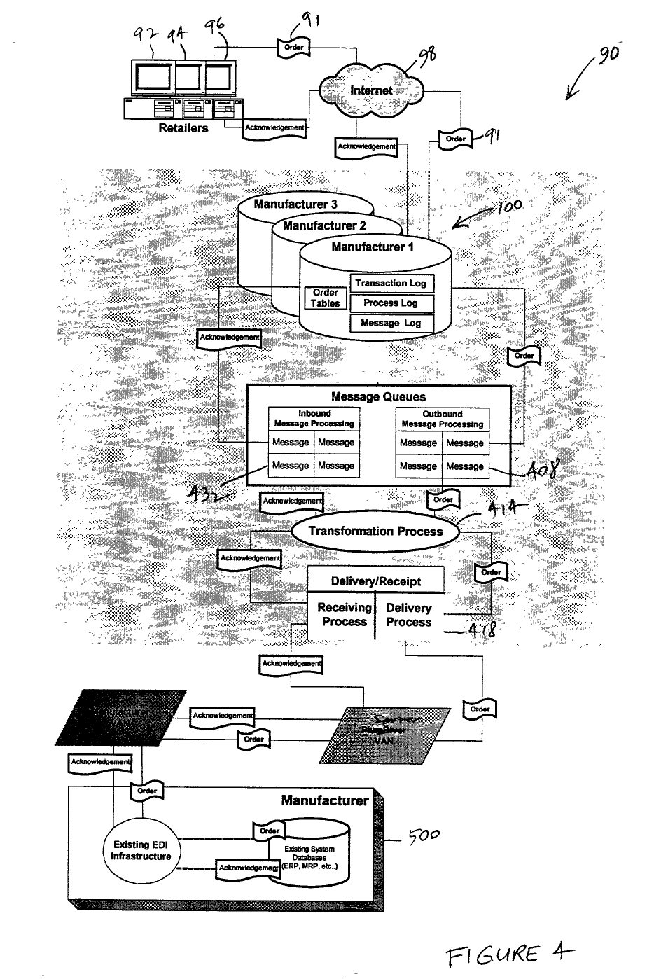

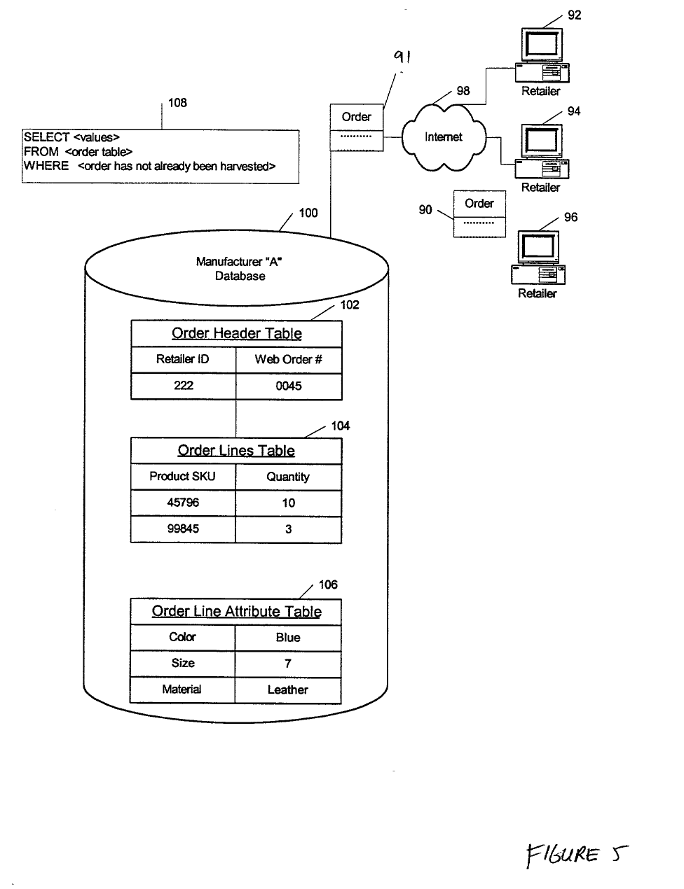

FIG. 4 shows an overview of the system architecture 90. FIGS. 5 through 11 show details of the architecture.

As shown in FIG. 5, orders 91 entered through the Internet 98 by retailers 92, 94, 96 are captured in a series of database tables of a database 100 associated with the manufacturer to which the orders are directed. The tables include an order header 102, order lines 104, and order line attributes 106. The information to fill the table are derived from information provided by the retailers through the web site, as described later. Using a SQL SELECT statement 108, orders entered by the retailer via the web can be “harvested” for use in other parts of the system.

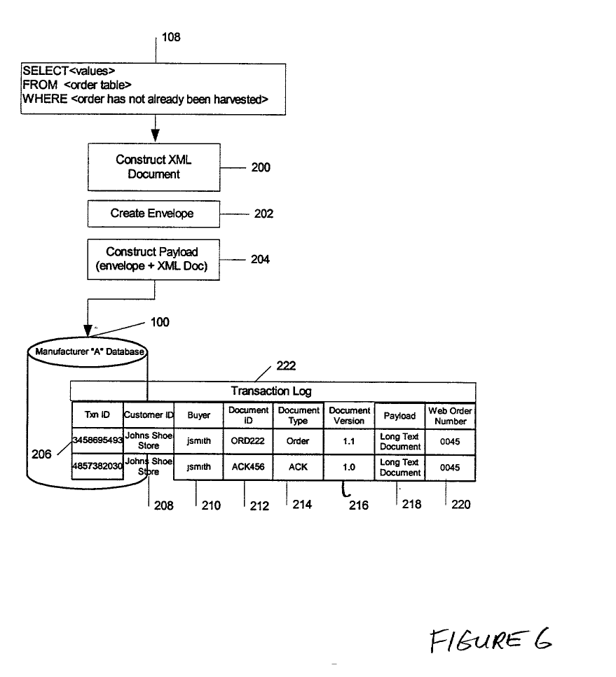

Referring to FIG. 6, harvesting 108 uses the information stored in the database 100 to construct a single Extensible Markup Language (XML) document 200 including one or more retailer orders associated with a single manufacturer. The order information, including retailer and web order details, is obtained from the order header, order lines, and order line attributes tables 102, 104, 106 (FIG. 5). After the XML document is created, an envelope 202 is constructed, capturing routing (e.g., the entity to which the order is directed, such as the manufacturer), document type (e.g., order, confirmation), and document version (e.g., 1.1) information. The envelope and XML document are then concatenated to form a payload 204. The payload contains all information pertaining to each of the retailers' orders. Payloads can have different lengths typically reflective of more or fewer items purchased.

Payloads are stored back into a so-called transaction log 222 of the manufacturer's database 100 as long text or character columns 218. This allows a single database table structure to be used for any number of document types and lengths.

Once the payload is constructed, a new row 206 is inserted into the transaction log table 222 of the manufacturer's database. The transaction log table serves as a single repository for all transaction documents and payloads for the manufacturer. Prior to inserting the new row in the transaction log table, certain values are extracted from the payload and externalized as discrete columns in the table. The entire payload, whatever its length, is stored in a single column 218 in the new transaction log row. The values that are externalized 208, 210, 212, 214, 216, and 220 are used by applications that need to select and sort the transaction log rows for later processing. Among other things, this arrangement enables retailers to view order history to obtain information such as order number, order date, items ordered, and related business documents (e.g. acknowledgement). An example of a payload is set forth in FIG. 7.

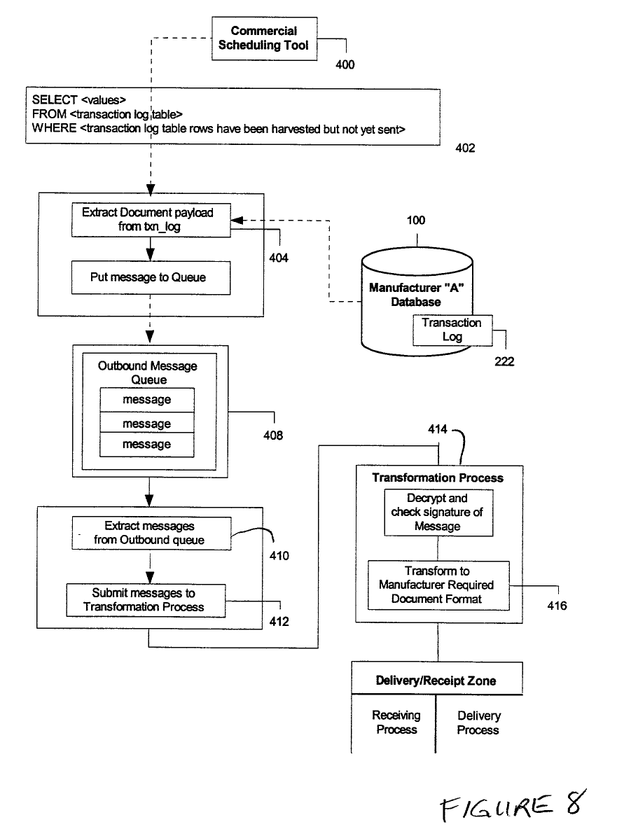

Referring to FIG. 8, a job scheduling tool 400 invokes a separate sending process, which selects transaction log rows that have not yet been sent to the manufacturer 402. The payload from the selected transaction log rows 404 is used to construct a message that is placed on an outbound message queue 408. The outbound message is destined for the manufacturer, for example.

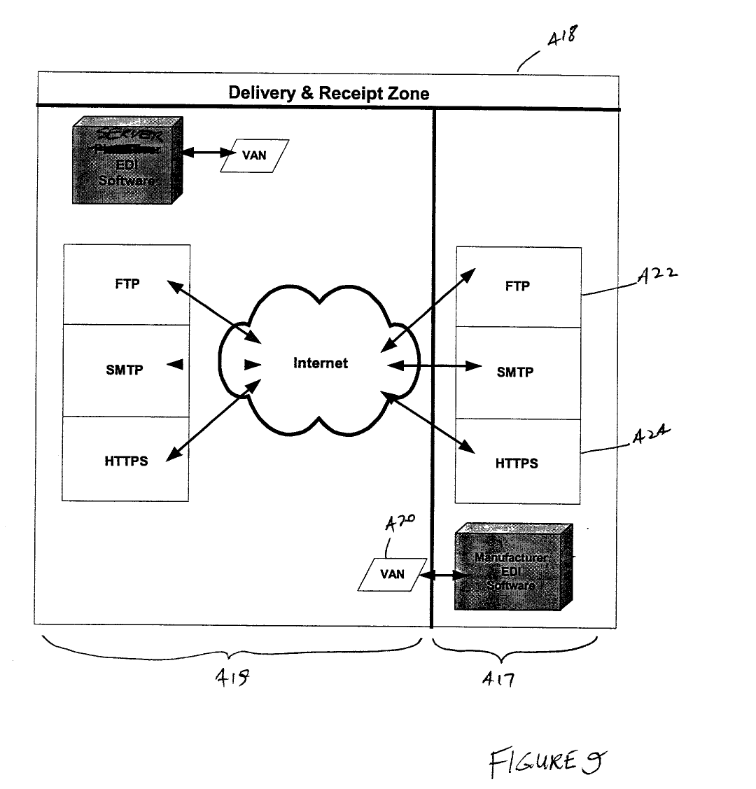

A transformation job is initiated to read these messages from the outbound message queue 410 and submit them to a data transformation process 412. This process 414 transforms the contents of the payload to specific document formatting requirements of the manufacturer 416, for example, to an EDI format. Transformed messages are then placed in a delivery/receipt zone 418, where they can be sent or picked up automatically by other processes or the manufacturer's computer system. The delivery/receipt zone 418, shown in FIG. 9, provides a loosely coupled architectural framework that allows one or more third party commercial software products to perform the transaction delivery and receipt functions to and from trading partners (e.g., customers, suppliers, manufacturers). The primary functions of the software implemented in this zone are the management of the delivery methods/protocols to/from customers or other trading partners. Using third party commercial software, independent delivery jobs run on predetermined schedules to deliver transformed messages to the manufacturer's side 417 of the delivery and receipt zone 417 using the manufacturer's preferred electronic delivery method. (e.g., private value added network 420 (VAN), FTP 422, HTTP/S 424, dial-up). Jobs operating on the manufacturer's systems acquire the delivered messages and are used to update the manufacturer's internal databases. During this process the manufacturer will assign unique identifying information to each order (e.g., a manufacturer specific order number). Thus, the delivery/receipt zone provides a medium that synchronizes the manufacturer's database with current information about incoming orders and other information from the retailers. Typically the manufacturer will automatically send a return message that acknowledges receipt of the electronic document. The return message can include additional information such as delivery date. In this way, the database in the server is kept synchronized with current information found in the manufacturer's internal database.

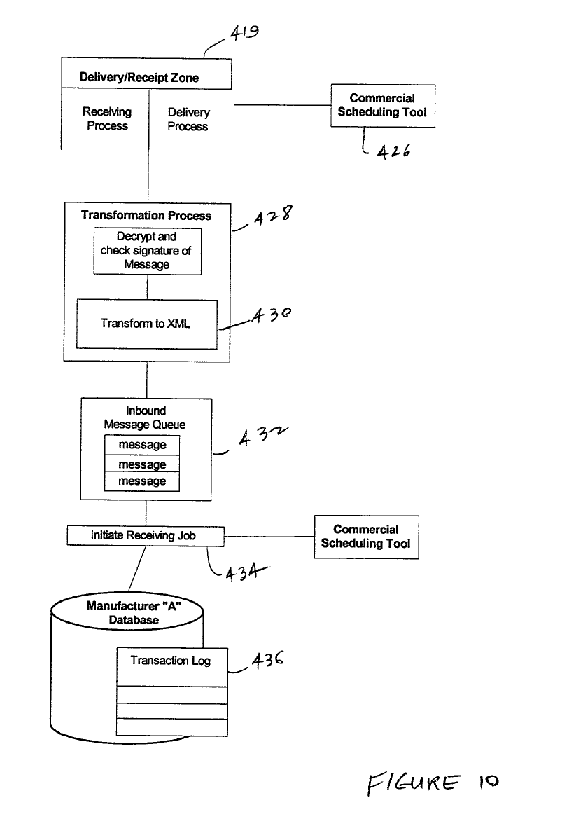

As shown in FIG. 10, for messages arriving from the manufacturer, the process is reversed. The manufacturer transmits the acknowledgement directly or indirectly to the delivery/receipt zone 419 associated with the server architecture. Third party commercial software is used to acquire the message or transaction and store it in the database in the site server. Using a scheduling function 426 inherent within the third-party product, the inbound message from the manufacturer is picked up and submitted to a transformation process 428 specific to the document type (e.g., acknowledgement, invoice). The transformation process converts the data from the manufacturer's specific format (EDI, for example) to an XML format 430 reflective of the server's document formatting standards. Then, the transformed XML document is probed for key data elements (e.g., customer, document type, document version), which are used to create the message envelope. Concatenating the message envelope and the resultant XML document forms a payload. Upon completion of the transformation process, a message consisting of the transformed message payload is placed on an inbound message queue 432. At predetermined intervals, a receiving job 434 is initiated to GET messages from the inbound queue and INSERT them into the transaction log 436 associated with that manufacturer.

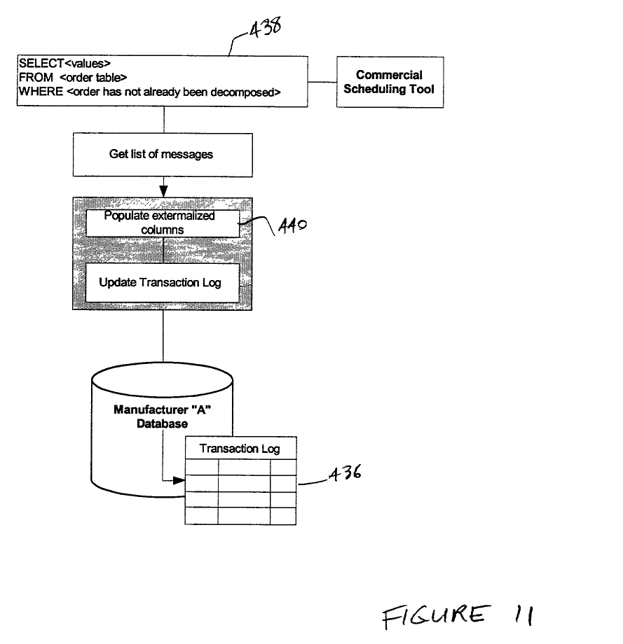

After the incoming messages have been stored, they require additional processing. As shown in FIG. 11, a decomposition job, running on a predetermined schedule, uses a select statement 438 to retrieve transaction log rows created by inbound message processing for decomposition. The decomposition process validates the XML structure and populates externalized columns 440 in the transaction log row 436, for reasons described in the harvesting job process. One of the externalized columns is used to thread acknowledgements and other electronic documents created or originated by the manufacturer (e.g. shipment notices, invoices) to the originating retailer order.

A separate email job (not shown) retrieves rows from the transaction log for which email notifications are required and which have not yet been sent. For each transaction row, an email is sent to the retailer indicating the arrival of the manufacturers order acknowledgement and/or other order related documents. Subsequently, the retailer can view the details associated with the manufacturer acknowledgements and other order related documents used by the manufacturer in communicating with large retailers threaded to the originating order. The view is constructed to facilitate any number of document threads provided by the manufacturer.

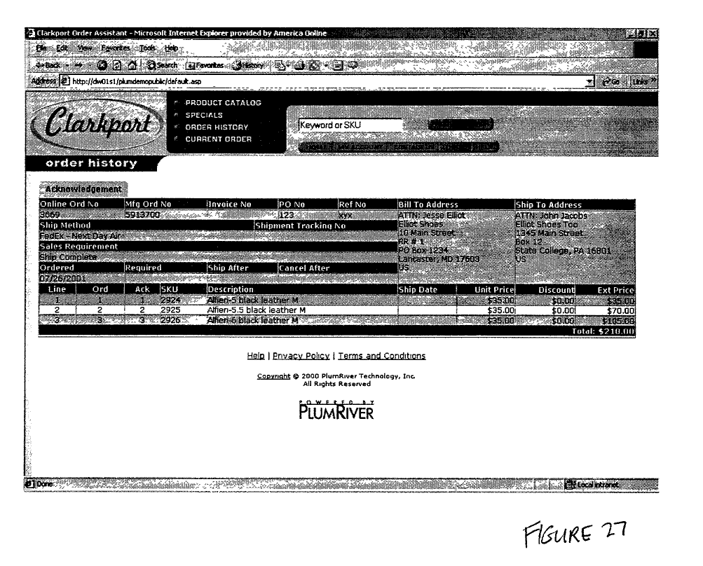

For example, a manufacturer XYZ may choose to communicate order acknowledgements and invoice information to its retailers, while another manufacturer UVW, in addition to this may choose to make advanced ship notices and order changes available to the retailer. The architecture can accommodate these differences between manufacturers without programming changes. Uniqueness in document presentations between manufacturer XYZ and manufacturer UVW is managed by a database reference to an XML transform, which converts the stored payload to the desired manufacturer presentation. FIGS. 27, 28, and 35 show three different transaction record presentations of similar kinds of order transaction data.

Order and related or threaded data is referred to as “transactional” data or a transactional data stream.

Non-transactional data or data streams which drive website content and functionality (for example, product images and descriptions, prices, other “catalog” information, and retailer account information) are also passed from the manufacturers to the server in messages and are processed through the same architecture. Typically, non-transactional data flows in a single direction (manufacturer to server site), while transactional data (as discussed earlier) will be both to and from the manufacturer. Non-transactional data streams also differ from transactional data streams in both frequency of delivery occurrence (typically less frequent) and transformation complexity (typically more complex). Following an initial transformation process, non-transactional data is stored in the transaction log in a similar manner to that described for transactional data. Non-transactional data subsequently is further transformed and used to update the discrete database tables and file systems, which comprise the manufacturers, web site content.

Returning to the overview of FIG. 4, the effect of the facilities discussed with respect to FIGS. 5 through 11 is that data passes between the retailers 92, 94, and 96 and manufacturer 500 by a messaging system. Orders are loaded into the databases 100 of the respective manufacturers to which the orders are directed and then into the message queue. The messages are pulled from the message queue, transformed to a format suitable for the target manufacturer, and passed through the delivery zone and the value added network or other electronic transport to the manufacturers' existing eCommerce infrastructure and then on to the existing manufacturer databases. The processing of acknowledgments occurs in the reverse way. Other steps in a transaction to and from the manufacturer are handled in a similar way.

The User Interface and Navigation

FIGS. 12 through 25 show web pages that present the interactive user interface to buyers and other representatives of a retailer. A wide variety of layouts and graphical elements can be provided on the web pages, only one of which is shown in the figures. The look and feel of the interface may be specified by the manufacturer or by the host of the system server or a combination of the two. A single manufacturer may specify different styles for web pages to be presented to different individual retailers or classes of retailers to maximize the effectiveness of the interface. Different styles might be presented, for example, to a small retailer and a large retailer. The choice of styles and the manner of presentation of retail item data may be controlled automatically by data stored in the manufacturer's database and accessible at the hosting server.

In the example shown in FIGS. 12 through 25, for example, a banner 150 at the top of each page includes a space 152 for the manufacturer's logo, a navigation bar 154 that is directed to housekeeping activities, and a second navigation bar 156 that leads to ordering activities.

When a retailer is invited to participate, the manufacturer provides the retailer with a registration code.

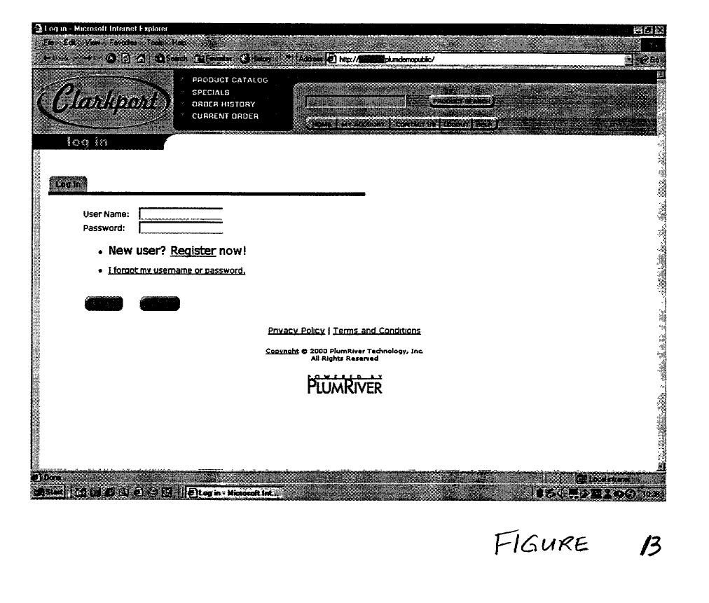

The first time a buyer at the retailer uses the system, he must first enter the retailer's registration number in box 158 and the last four digits of the buyer's telephone number in box 160. He then clicks the button 162 labeled log in and is taken to the page shown in FIG. 13, the login screen. The process is designed to allow the retailer to enter a unique username and password as is done in establishing an account with other commercial web sites.

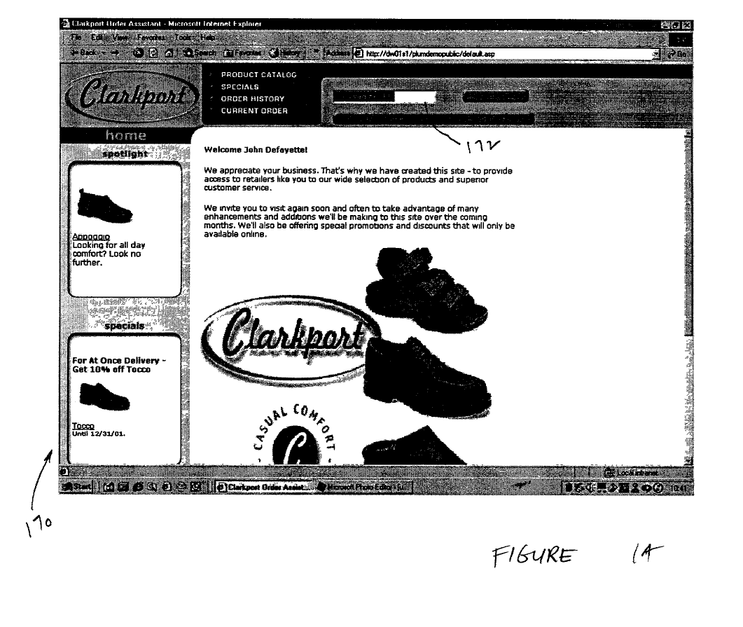

Each time the retailer uses the system the user enters his name 164 and a password 166 and clicks the log in button 168 and is taken to the welcome page, FIG. 14.

The welcome page includes a bar 170 on the side in which the manufacturer may feature promotional items that may be of interest to the buyer. A search box 172 enables the buyer to search for products of interest.

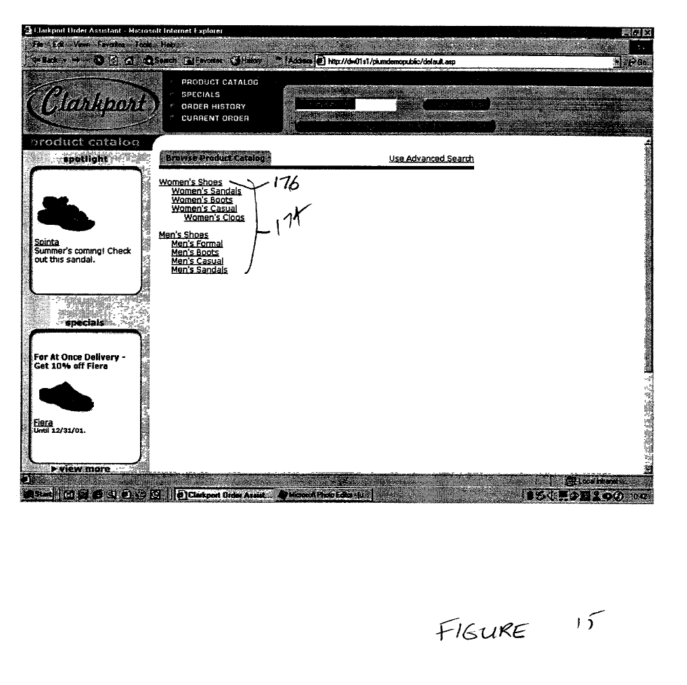

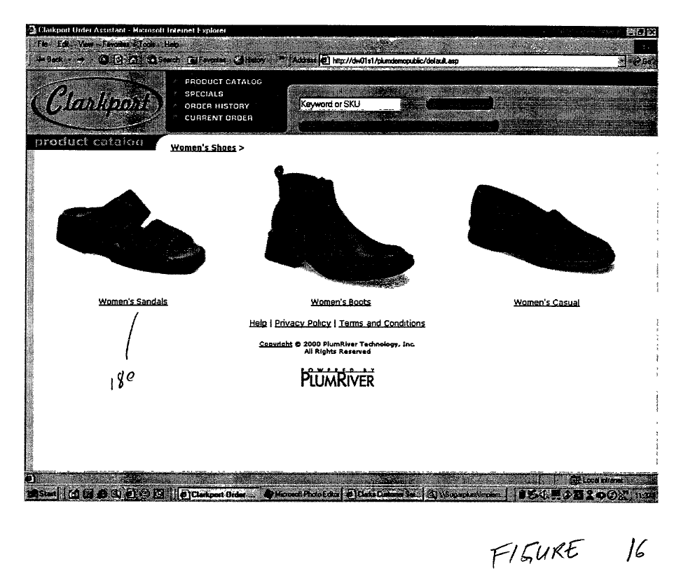

If the buyer selects the product catalog button, he is presented with the page shown in FIG. 15. An outline of links 174 may then be invoked to choose a section of the catalog. If a link that is not at the bottom level of the hierarchy is selected, for example, women's shoes 176, the buyer is taken to a page that illustrates the retail item groups at the next level of the hierarchy, as shown, for example, in FIG. 16.

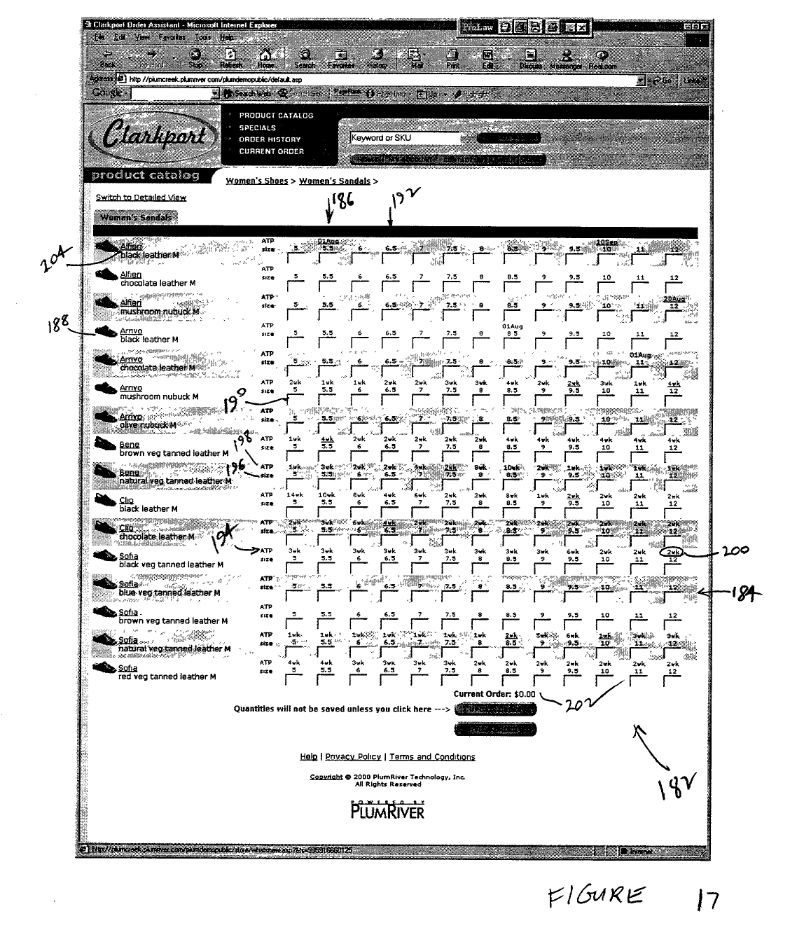

By invoking women's sandals 180, the buyer is then presented with an item selection page (e.g., FIG. 17) on which numbers of pairs of shoes can be selected for an order.

The item selection page is arranged in a grid 182 of rows 184 and columns 186. Each row pertains to a single product or style. For example, row 188 pertains to show style Arrivo in black leather medium width.

Each column pertains to a shoe size. For example, column 192 pertains to size 6½. The column attribute value that is represented on the horizontal axis (or row) is defined in the database for each manufacturer. When the pages are formed and served by the site server, the information in the database is used to determine how the catalog information is actually presented on the page. This allows the system to be adapted to different industries or vertical markets. For example, a bike manufacturer might want to represent bike frame sizes across the horizontal axis while an eyewear manufacturer may choose to represent lens types.

Along each row are boxes 190 in which a buyer can enter numbers to select a number of pairs of shoes of a given SKU and length to be included in an order. The buyer can enter numbers in one or more than one boxes without linking to any other pages in order to complete his selections for the given class of retail item (in this case, women's sandals). This makes the process of completing selections for an order much faster and simpler than if the buyer were required to link to a different page for each of the items that he wanted to select.

Above each row of boxes are two lines of information. One line 196 identifies the shoe sizes. The other line 198 identifies, if information is available, the available to promise (ATP) provides information to the retailer relative to current and future availability of the retail item. For example, entry 200 indicates that the anticipated production date for Sofia black vegetable tanned leather in medium width and length 12 is two weeks.

The total dollar value of the current order is shown at the bottom of the grid 202.

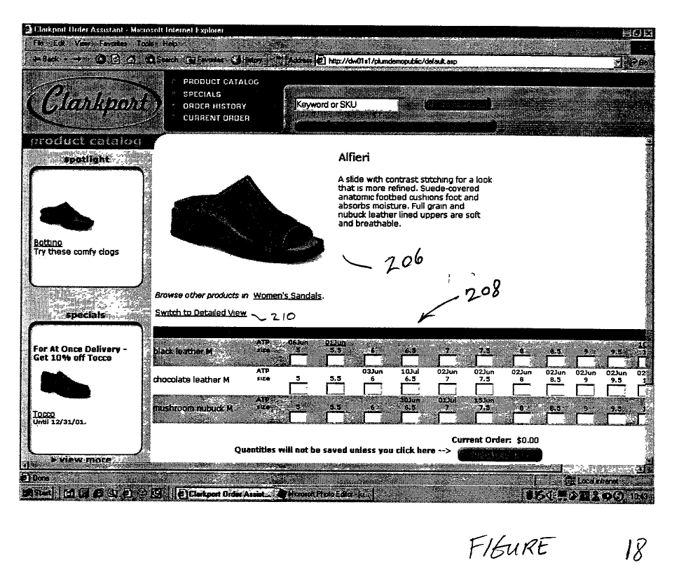

By invoking the link 204 next to the item image, the buyer is taken to the style page shown in FIG. 18. The style page includes an illustration 206 of the style and a grid of boxes 208, similar to the grid on FIG. 17.

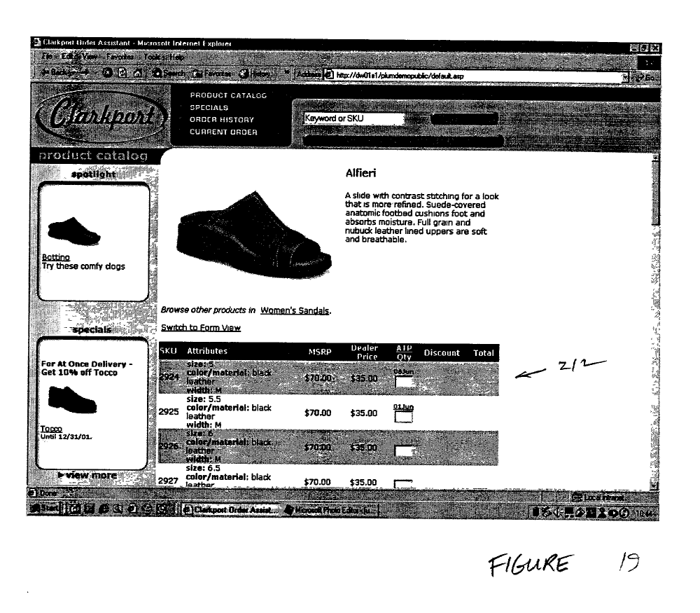

The buyer may view the item information in a different layout by invoking the link 210, which triggers the presentation of the view shown in FIG. 19. In that view each row 212 refers only to a single width and size and reports the SKU number, the manufacturer's suggested retail price, and the dealer's price.

As before, the buyer may select a number of each item and size to buy by entering the number in the box that appears in the row.

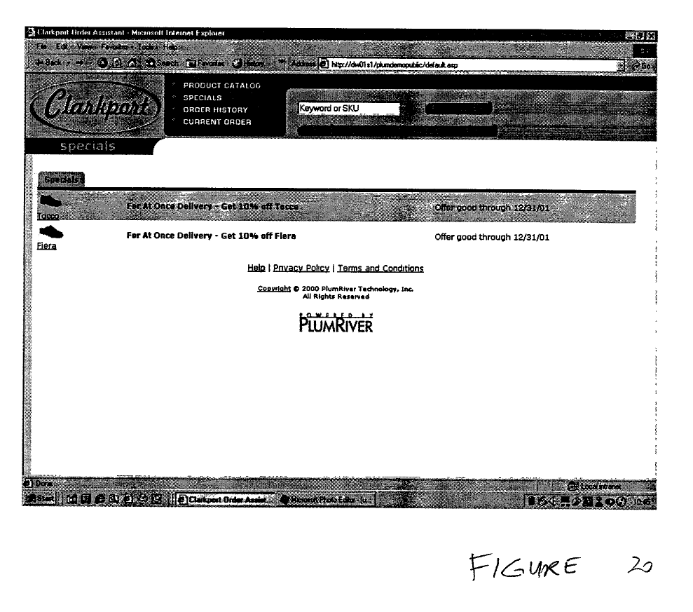

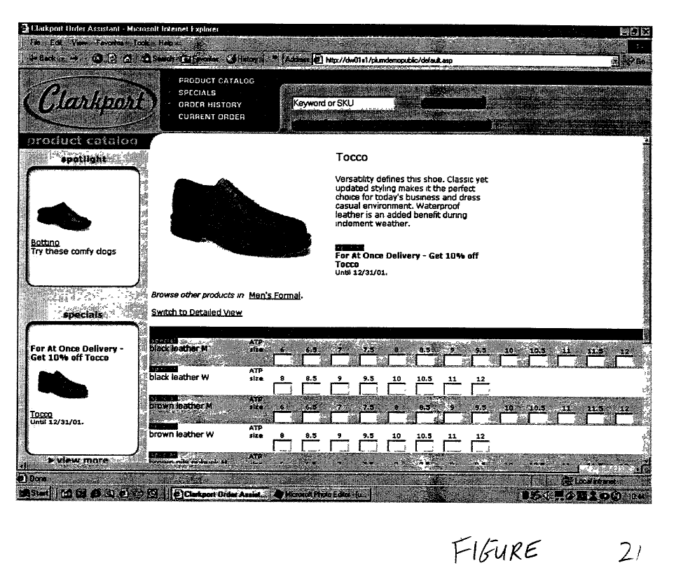

By clicking the word “specials” in the navigation bar at the top of the page, the user is taken to a page shown in FIG. 20 in which items on special are listed by SKU. By clicking on one of the SKU's the reader is taken to the page shown in FIG. 21, which lists the specials for that SKU. The information about specials is derived from data that is held in the manufacturer's database and is accessible to the host server as explained earlier.

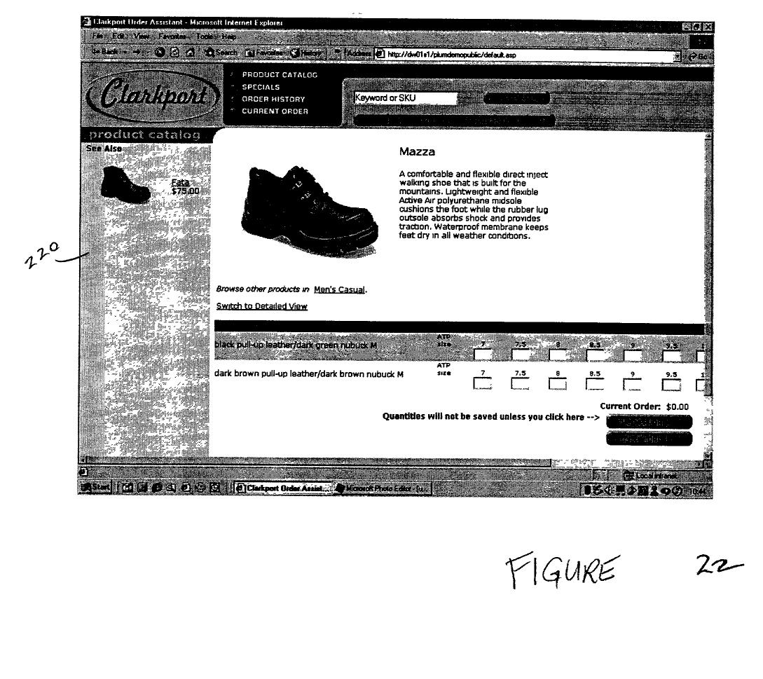

During the display of a page that is focused on a particular SKU, such as the page shown in FIG. 22, the left side bar may present a cross-selling promotion to the buyer. The cross-selling promotional information may be displayed automatically based on information stored in the manufacturer's database that associates different SKUs which presents cross-selling opportunities. This data is part of the non-transactional data stream defined for the system that the manufacturer will transmit to the server site from time to time. The buyer can view and submit his order using various pages of the interface.

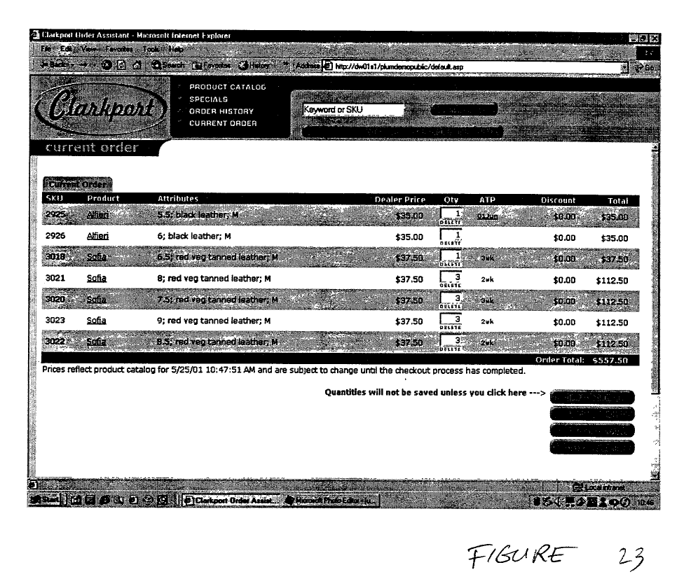

When the buyer invokes the current order button on the navigation bar, or the view order button on certain other pages, he is presented the current order page shown in FIG. 23. The current order page lists the amounts and prices of all of the items that have been selected and the ATP value for each of them.

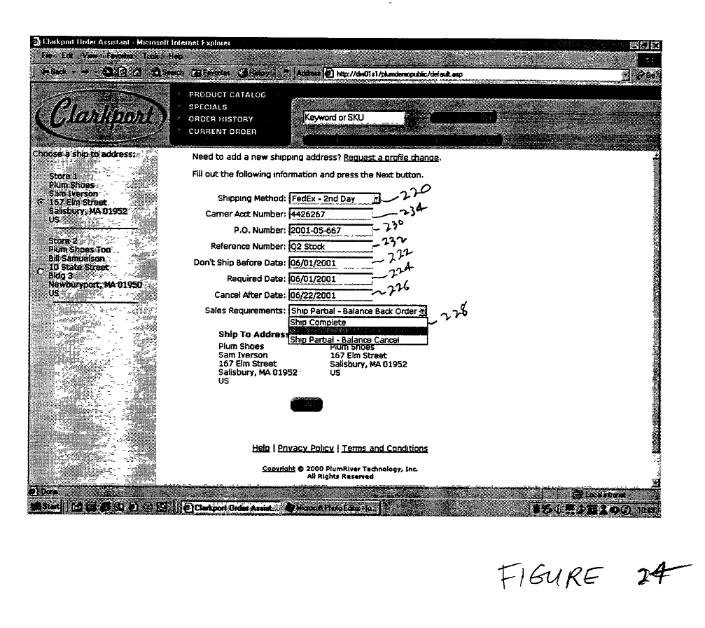

When the buyer is ready to complete his order, he is presented with the page shown in FIG. 24. The page allows the user to choose a shipping method 220, a don't ship before date 222, a required date 224, a cancel after date 226, and instructions for dealing with unavailable items 228. The user may also enter a purchase order number and a reference number 230, 232. The carrier account number 234 is entered automatically based on retailer information provided by the manufacturer's non-transactional data stream.

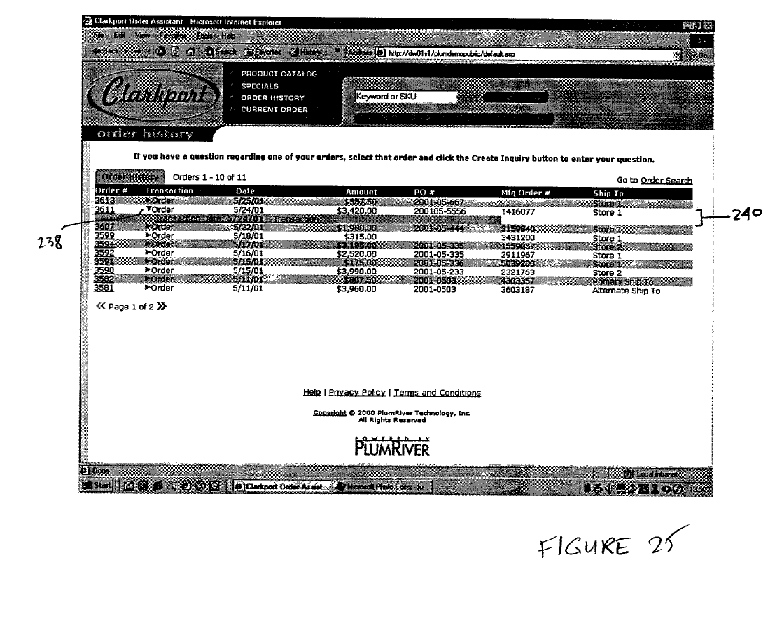

An order history page, shown in FIG. 25, provides an historical list of orders for a retailer. An arrow 238 in each line enables the buyer to drill down an order to see a sequence of entries 240 that relates to that order.

Other implementations are within the scope of the following claims.

1. A method comprising
maintaining an on-line facility that provides to a retailing customer of a supplier information about the status of transactions involving products of the supplier, the information provided on the on-line facility including information about transactions that are entered by the retailer in the on-line facility and information about transactions that are entered other than through the on-line facility.

2. The method of claim 1 in which
the information about the status of transactions is provided from a database,
the database is updated automatically by the on-line facility to reflect transactions entered by the retailer, and
the database is also updated to reflect at least some of the transactions that are entered other than through the on-line facility.

3. The method of claim 2 in which the database is maintained independently of the supplier and is synchronized with a database maintained by the supplier by electronic communication.
